(19) United States
(12) Patent Application Publication
(10) Pub. No.: US 2019/0169376 A1
(43) Pub. Date: Jun. 6, 2019

(54) Method to Improve Remote Phosphor Optical Properties in Polycarbonate

(71) Applicant: SABIC Global Technologies B.V., Bergen op Zoom (NL)

(72) Inventors: Christopher Luke Hein, Evansville, IN (US); Franklin Ehrensbeck, Evansville, IN (US); Brett D. Ermi, Schenectady, NY (US); Bing Zhou, Evansville, IN (US); Guangxin Lin, Vernon, IN (US); Roger W. Hurst, Mount Vernon, IN (US)

(21) Appl. No.: 16/313,389

(22) PCT Filed: Jun. 27, 2017
(86) PCT No.: PCT/US2017/039425

§ 371 Date: Dec. 26, 2018

Related U.S. Application Data
(60) Provisional application No. 62/356,145, filed on Jun. 29, 2016.

(51) Int. Cl. C08J 3/22; C08L 69/00; C08L 27/18; B29C 48/27

(52) U.S. Cl. CPC C08J 3/22; C08L 69/00; C08L 27/18; B29C 48/022; C08J 2369/00; C08J 2427/18; B29C 48/272

(57) ABSTRACT

The disclosure concerns compositions and methods to improve remote phosphor optical properties in polycarbonate. One method includes combining a phosphor component and a polycarbonate component to form a phosphor-polycarbonate composition; and at a fixed phosphor concentration, combining the phosphor-polycarbonate composition with a diffusing agent comprising polytetrafluoroethylene (PTFE), wherein the diffusing agent diffuses light, and wherein the phosphor-polycarbonate composition exhibits an increase in chromaticity coordinate (CIEx) as determined by CIE 1931 or increase in CIE 1976 (u′,v′) of at least about 5% relative to a substantially similar reference composition in the absence of PTFE. Also described are methods to increase yield and reduce product accumulation of an extruded thermoplastic polycarbonate composition through the mixing of PTFE with a phosphor-polycarbonate (PCP) to form a PCP-PTFE component as well as a method forming a phosphor-polycarbonate master batch (PPCMB) composition, and during extrusion, adding PTFE to the PPCMB composition to form a PPCMB-PTFE composition.

### TECHNICAL FIELD

This disclosure concerns a method to improve remote phosphor optical properties in polycarbonate, such as the addition of a unique composition of polytetrafluoroethylene (PTFE) to a phosphor-polycarbonate composition where the phosphor concentration is fixed.

Additionally, this disclosure concerns a method to increase product yield during the extrusion process. Specifically, the addition of PTFE reduces observed die-lip accumulation.

### BACKGROUND

Phosphors blended in polycarbonate are intended to satisfy specific conversion efficacy and chromaticity requirements of emitted light when irradiated with a blue light emitting diode LED light or laser source. In some cases, a first phosphor may be blended with a second phosphor to achieve a desired efficacy and color white point. In the case of remote phosphor manufacturers, a total inorganic solids content is additionally specified for cost purposes. Total solids means total phosphor loading level. When the phosphor concentration is fixed, very little can be done to generate a suite of remote phosphor products since conversion efficacy and color will be static once blended and extruded in a polycarbonate matrix.

In addition, during extrusion significant die-lip build up accumulation of product results in a yield no greater than 50% or about 50%.

These and other shortcomings are addressed by aspects of the present disclosure.

### SUMMARY

The disclosure concerns a method to improve remote phosphor optical properties in polycarbonate, the method comprising: combining a phosphor component and a polycarbonate component to form a phosphor-polycarbonate composition; and at a fixed phosphor concentration, combining the phosphor-polycarbonate composition with a diffusing agent comprising polytetrafluoroethylene (PTFE), wherein the diffusing agent diffuses light, and wherein the phosphor-polycarbonate composition exhibits an increase in chromaticity coordinate as determined according to the standard International Commission on Illumination for color chromaticity CIE 1931 (CIEx) or CIE 1976 (chromaticity coordinates u′,v′) of at least about 5% as compared to a substantially similar reference composition in the absence of PTFE.

The inclusion of PTFE in the composition also results in a corresponding decrease in correlated color temperature (CCT). In some aspects the PTFE is a low molecular weight PTFE having a molecular weight of about 300 Kelvin (K) to about 400K. In certain aspects the phosphor-polycarbonate composition includes a PTFE level of about 0.3 weight percent (wt. %) to about 2.0 wt. %.

Compositions are disclosed. One composition may include: from about 80.0 wt. % to about 99.5 wt. % of a polycarbonate component; wherein a melt volume rate of the polycarbonate component is greater than about 15 cubic centimeters per 10 minutes (cm³/10 min) as determined according to ISO 1133 at 300° C./1.2 kilograms (kg), and wherein a melt flow rate of the polycarbonate component is greater than about 15 grams per 10 minutes (g/10) min as determined according to ASTM D 1238 at 300° C./1.2 kilogram·force (kgf); from about 0.3 wt. % to about 2.0 wt. % PTFE, wherein the PTFE diffuses light; from about 0 wt. % to about 0.6 wt. % potassium perfluorobutane sulfonate; from about 0 wt. % to about 0.6 wt. % phosphite stabilizer; and from about 0 wt. % to about 0.2 wt. % hindered phenol anti-oxidant; and wherein the composition exhibits an increase in CIEx as determined according to CIE 1931 or CIE 1976 (u′,v′) of at least about 5% as compared to a substantially similar reference composition in the absence of PTFE.

The disclosure further describes methods to achieve greater product yield during extrusion through the reduction of die-lip accumulation. Specifically, the integration of PTFE within the phosphor-polycarbonate composition as well as the addition of PTFE to a phosphor-polycarbonate master batch (PPCMB) composition during extrusion each facilitate greater product yield and reduce die-lip accumulation.

### DETAILED DESCRIPTION

Thermoplastics comprise a large family of polymers, most of which have a high molecular weight. Intermolecular forces are responsible for the association of the molecular chains, which allows thermoplastics to be heated and remolded. Thermoplastics become pliant and moldable at a temperature above their glass transition temperature but below their melting point, and the intermolecular forces reform after molding and upon cooling of the thermoplastic, resulting in the molded product having substantially the same physical properties as the material prior to molding.

### Polycarbonate (PC)

Polycarbonates fall within the thermoplastic family and contain carbonate groups —O—(C═O)—O—. Polycarbonates find widespread use throughout industry due to their excellent strength and impact resistance. Additionally, polycarbonates may be readily machined, cold-formed, extruded, thermoformed and thermo-molded.

The composition disclosed herein comprises 85 wt. % to 99.86 wt. % or from about 85 wt. % to about 99.86 wt. % polycarbonate polymer based on the weight of the composition.

The terms “polycarbonate” or “polycarbonates” as used herein includes general purpose polycarbonate homopolymers, copolycarbonates, homopolycarbonates, (co)polyester carbonates, and combinations thereof. PC polymers are available commercially from SABIC.

The disclosed interfacial process enhances the optical properties of BPA polycarbonate (e.g., LEXAN™ polycarbonate), upgrading transparency and improving the durability of this transparency by lowering the blue light absorption.

While various types of polycarbonates could potentially be used in accordance with aspects of the disclosure and are described in detail below, of particular interest are bisphenol A (BPA) based polycarbonates, such as LEXAN™ polycarbonate (available from SABIC™). More particularly, according to certain aspects, LEXAN™ polycarbonate can be used for a wide range of applications that make use of its interesting combination of mechanical and optical properties. Its high impact resistance can make it an important component in numerous consumer goods such as mobile phones, MP3 players, computers, laptops, etc. Due to its transparency, this BPA polycarbonate can find use in optical media, automotive lenses, roofing elements, greenhouses, photovoltaic devices, and safety glass. The developments in light emitting diode (LED) technology have led to significantly prolonged lifetimes for the lighting products to which this technology can be applied. This has led to increased requirements on the durability of polycarbonates, in particular on its optical properties. In other applications such as automotive lighting, product developers may feel the need to design increasingly complex shapes which cannot be made out of glass and for which the heat requirements are too stringent for polymethyl methacrylate (PMMA). Also in these applications polycarbonate is the material of choice, but the high transparency of PMMA and glass should be approached as closely as possible.

As noted above, although BPA polycarbonates, such as LEXAN™ polycarbonates are of particular interest, various polycarbonates could potentially be employed in the aspects disclosed herein.

The term polycarbonate can be further defined as compositions have repeating structural units of the formula (1):

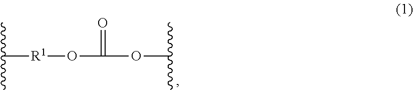

in which at least 60 percent of the total number of R1 groups are aromatic organic radicals and the balance thereof are aliphatic, alicyclic, or aromatic radicals. In a further aspect, each R1 is an aromatic organic radical and, in some aspects, a radical of the formula (2):

-A¹-Y1-A² (2),

wherein each of A1 and A2 is a monocyclic divalent aryl radical and Y1 is a bridging radical having one or two atoms that separate A1 from A2. In various aspects, one atom separates A1 from A2. For example, radicals of this type include, but are not limited to, radicals such as —O—, —S—, —S(O)—, —S(O2)-, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y1 may include a hydrocarbon group or a saturated hydrocarbon group such as methylene, cyclohexylidene, or isopropylidene. Polycarbonate materials include materials disclosed and described in U.S. Pat. No. 7,786,246, which is hereby incorporated by reference in its entirety.

Generally polycarbonates can have a weight average molecular weight (Mw), of greater than 5,000 grams per mole or greater than about 5,000 grams per mole (g/mol) based on polystyrene PS standards. In one aspect, the polycarbonates can have an Mw of greater than or equal to 20,000 g/mol or greater than about 20,000 g/mol, based on PS standards. In another aspect, the polycarbonates have an Mw based on PS standards of about 20,000 to 100,000 g/mol, including for example 30,000 g/mol, 40,000 g/mol, 50,000 g/mol, 60,000 g/mol, 70,000 g/mol, 80,000 g/mol, or 90,000 g/mol. In still further aspects, the polycarbonates have an Mw based on PS standards of about 22,000 to about 50,000 g/mol. In still further aspects, the polycarbonates have an Mw based on PS standards of about 25,000 to 40,000 g/mol.

In certain aspects, the polycarbonate may comprise two or more polycarbonate compositions that differ in molecular weight and/or compositional variations.

In certain aspects, the polycarbonate may be comprised of a high flow composition. High flow refers to the melt flow rate of the polycarbonate. Thus, high flow polycarbonate refers to a composition that has a melt volume rate (MVR) of at least about 15 cm³/10 min as determined according to ISO 1133 at 300° C./1.2 kg and/or a melt flow rate (MFR) of 15 g/10 min as determined according to ASTM D 1238 at 300° C./1.2 kgf.

Certain polycarbonates are sold under the trade name LEXAN™ by SABIC™.

### Phosphors

Phosphors, also known as “luminescent conversion materials”, can be compounded into the polycarbonate compositions disclosed herein. In one aspect, the phosphor material is configured to convert light emitted by a light source such as a light-emitting diode (LED) into light having a different wavelength. For example, the phosphor material may be configured to convert the light emitted by an LED to a longer wavelength as needed.

Phosphors are typically inorganic compounds. Examples of phosphor materials include yttrium aluminum garnet (YAG) doped with rare earth elements, terbium aluminum garnet doped with rare earth elements, silicate (Barium Ortho-Silicate Europium BOSE) doped with rare earth elements; nitrido silicates doped with rare earth elements; nitride orthosilicate doped with rare earth elements, and oxonitridoaluminosilicates doped with rare earth elements. Phosphors that may be useful in aspects of the disclosure may be found in U.S. Pat. No. 8,597,545 B1 by Liu et al, which is hereby incorporated by reference in its entirety. Exemplary, but by no means limiting phosphors include:

A red-emitting phosphor comprising a nitride-based composition represented by the chemical formula MₐSr_{b}Si_{c}Al_{d}NₑEu_{f}, wherein M is Ca, Sr is strontium, Si is silicon, Al is aluminum, N is Nitrogen, Eu is Europiumand 0.1≤a≤0.4; 1.5<b<2.5; 4.0≤c≤5.0; 0.1≤d≤0.15; 7.5<e<8.5; and 0<f<0.1; and wherein a+b+f>2+d/v and v is the valence of M.

A second exemplary, non-limiting phosphor includes a red-emitting phosphor, further comprising at least one of fluorine F, chlorine Cl, bromine Br and oxygen O.

Semiconductor nanocrystals, or quantum dots, within the range of 2 nanometers (nm) to 10 nm, comprising inorganic materials, usually cadmium based phosphorescent compounds, may also be used to form opaque and translucent polycarbonates.

The phosphor material is typically in the form of a solid powder. The phosphor material may include red-emitting phosphors, green-emitting phosphors, and yellow-emitting phosphors. In one aspect, the phosphor material may comprise a mixture of two or more of red-emitting phosphor, green-emitting phosphor and yellow-emitting phosphor.

In some aspects, the phosphor material can comprise Si, Sr, barium Ba, Ca, Eu, yttrium Y, terbium Tb, boron B, N, selenium Se, titanium Ti, or a combination comprising at least one of the foregoing. The phosphor can comprise greater than 0 parts per million (ppm) of a first material comprising Si, Sr, Ba, Ca, Eu, or a combination comprising at least one of the foregoing; and less than 50 ppm of a second material comprising Al, cobalt Co, iron Fe, magnesium Mg, molybdenum Mo, sodium Na, nickel Ni, palladium Pd, phosphorous P, rhodium Rh, antimony Sb, Ti, zirconium Zr, or a combination comprising at least one of the foregoing based on the total weight of the phosphor. The phosphor can comprise greater than 0 ppm of a first material consisting of Si, Sr, Ba, Ca, Eu, or a combination comprising at least one of the foregoing; and less than 50 ppm of a second material consisting of Al, Co, Fe, Mg, Mo, Na, Ni, Pd, P, Rh, Sb, Ti, Zr, or a combination comprising at least one of the foregoing based on the total weight of the phosphor.

The phosphor can comprise a yttrium aluminum garnet, a terbium aluminum garnet, a boron silicate; a nitrido silicates; a nitride orthosilicate, a oxonitrido aluminosilicates, or a combination comprising at least one of the foregoing. The phosphor can comprise a strontium silicate yellow phosphor, a yttrium aluminum garnet, a terbium aluminum garnet, a silicate phosphor, a nitride phosphor; a nitrido silicate, a nitride orthosilicate, an oxonitridoaluminosilicate, an alumino nitrido silicate, a nitridoaluminate, a lutetium aluminum garnet, or a combination comprising at least one of the foregoing. The alumino nitrido silicate can comprise CaAlSiN₃:Eu that can be free of Sr (i.e., can comprise 0 wt. % of Sr), (Sr,Ca)AlSiN₃:Eu), or a combination comprising at least one of the foregoing.

The phosphor can comprise a lutetium aluminum garnet containing at least one alkaline earth metal and at least one halogen dope with a rare earth element.

The phosphor can comprise a rare earth element, cerium or europium for example, as a dopant.

In certain aspects, the phosphor can comprise green-emitting lutetium aluminate phosphor comprising lutetium, cerium, at least one alkaline earth metal, aluminum, oxygen, and at least one halogen.

Some phosphor materials can convert some of the blue light from a blue LED to yellow light, and the overall combination of available light is perceived as white light to an observer.

The phosphor can comprise a phosphor having formula: (A³)₂SiO₄:Eu²⁺D¹, where A³ is a divalent metal selected from Sr, Ca, Ba, Mg, zinc Zn, cadmium Cd, and combinations comprising at least one of the foregoing, and D¹ is a dopant selected from F, Cl, Br, iodine I, P, sulfur S or N, and optionally combinations comprising at least one of the foregoing.

The phosphor can comprise a phosphor having formula: (A⁴)₂SiO₄:Eu²⁺D² with D² an optional dopant selected from Al, Co, Fe, Mg, Mo, Na, Ni, Pd, P, Rh, Sb, Ti or Zr, and optionally combinations comprising at least one of the foregoing, wherein A⁴ is selected from Sr, Ba, Ca, and combinations comprising at least one of the foregoing.

The phosphor can comprise a phosphor having formula: (YA⁵)₃(AlB)₅(OD³)₁₂:Ce³⁺, where A⁵ is a trivalent metal selected from gadolinium Gd, Tb, lanthanum La, samarium Sm, or a divalent metal ion such as Sr, Ca, Ba, Mg, Zn, Cd, and combinations comprising at least one of the foregoing; B is selected from Si, B, P, and gallium Ga, and optionally combinations comprising at least one of the foregoing; and D³ is a dopant selected from F, Cl, Br, I, P, S or N, and optionally combinations comprising at least one of the foregoing. Other possible yellow material(s) include: Y₃Al₅O₁₂:Ce; Tb₃₋ₓREₓAl₅O₁₂:Ce (terbium aluminum garnet TAG based), wherein RE=Y, Gd, La, lutetium Lu; Sr_{2-x-y}BaₓCa_{y}SiO₄:Eu; Sr₃₋ₓSiO₅:Eu²⁺ₓ, wherein 0<x≤1. Possible yellow/green material(s) include: (Sr,Ca,Ba)(Al,Ga)₂S₄:Eu²⁺; Ba₂(Mg,Zn)Si₂O₇:Eu²⁺; Gd_{0.46}Sr_{0.31}Al_{1.23}OₓF_{1.38}:Eu²⁺_{0.06}; (Ba_{1-x-y}SrₓCa_{y})SiO₄:Eu; and Ba₂SiO₄:Eu²⁺.

The phosphor material can comprise a phosphor having formula: (YGd)₃Al₅O₁₂:Ce³⁺ or Y₃Al₅(OD³)₁₂:Ce³⁺.

The phosphor can comprise an orange-red silicate-based phosphor(s) having formula: (SrM1)₃Si(OD⁴)₅:Eu, where M1 is selected from Ba, Ca, Mg, Zn, and combinations comprising at least one of the foregoing; and D⁴ is selected from F, Cl, S, and N, and optionally combinations comprising at least one of the foregoing; phosphor(s); a Eu²⁺ doped and or Dy³⁺ phosphor(s) having formula: M₃MgSi₂O₈, wherein M is selected from Ca, Sr, Ba, and combinations comprising at least one of the foregoing.

The phosphor can comprise a red silicon nitride based Eu²⁺ doped phosphor(s) having a formula: (SrM2)₂Si₅N₈, where M2 is selected from Ca, Mg, and Zn and combination comprising at least one of the foregoing. Other nitridosilicates, oxonitridosilicates, oxonitridoaluminosilicates examples include: Ba₂SiN₈:Eu²⁺; alpha-SiAlON:Re (Re═Eu²⁺, Ce³⁺, Yb²⁺, Tb³⁺, Pr³⁺, Sm³⁺, and optionally combinations comprising at least one of the foregoing); Beta-SiAlON:Eu²⁺; Sr₂Si₅N₈:Eu²⁺,Ce³⁺; a rare earth doped red sulfide based phosphor (such as (SrM3)S, where M3 is selected from Ca, Ba, and Mg, and optionally combinations comprising at least one of the foregoing); SrₓCa₁₋ₓS:Eu,Y, wherein Y is a halide; CaSiAlN₃:Eu²⁺; Sr_{2-y}Ca_{y}SiO₄:Eu; Lu₂O₃:Eu³⁺; (Sr₂₋ₓLaₓ)(Ce₁₋ₓEuₓ)O₄; Sr₂Ce₁₋ₓEuₓO₄; Sr₂₋ₓEuₓCeO₄; SrTiO₃:Pr³⁺,Ga³⁺; CaAlSiN₃:Eu²⁺; Sr₂Si₅N₈:Eu²⁺, or a combination comprising at least one of the foregoing.

The phosphor can comprise a blue phosphor such as BaMgAl₁₀O₁₇:Eu²⁺.

The phosphor can comprise a green sulfide based phosphor such as (SrM3)(GaM4)₂S₄:Eu; where M3 is set forth above, and M4 is selected from Al and In.

The phosphor can comprise Tb₃₋ₓRE¹ₓO₁₂:Ce(TAG), wherein RE¹ is selected from Y, Gd, La, Lu, and combinations comprising at least one of the foregoing; yttrium aluminum garnet (YAG) doped with cerium (e.g., (Y,Gd)₃Al₅O₁₂:Ce³⁺; YAG:Ce); terbium aluminum garnet doped with cerium (TAG:Ce); a silicate phosphor material (e.g., (Sr)₂SiO₄:Eu, (Ba)₂SiO₄:Eu, (Ca)₂SiO₄:Eu); a nitride phosphor material (e.g., doped with cerium and/or europium); a nitrido silicate (e.g., LaSi₃N₅:Eu²⁺, O²⁻ or Ba₂Si₅N₈:Eu²⁺); a nitride orthosilicate (e.g., such as disclosed in DE 10 2006 016 548 Al); or combinations comprising at least one of the foregoing. The coated YAG:Ce based phosphor material(s) can be synthetic aluminum garnets, with garnet structure A₃³⁺B₅³⁺O₁₂²⁻ (containing Al₅O₁₂⁹⁻ and A is a trivalent element such as Y³⁺). The aluminum garnet can be synthetically prepared in such a manner (annealing) as to impart a short-lived luminescence lifetime lasting less than 10⁻⁴ s. Other possible green phosphor material(s) include: SrGa2S₄:Eu, Sr_{2-y}BaySiO₄:Eu, SrSiO₂N₂:Eu, and Ca₃Si₂O₄N₂:Eu²⁺.

The phosphor can comprise a yellow phosphor(s) (such as (Y,Gd)₃Al₅O₁₂:Ce3+ or (Sr,Ba,Ca)₂SiO₄:Eu) and a red phosphor material(s) (such as (Sr,Ca)AlSiN₃:Eu), e.g., to produce a warm white light. The phosphor material(s) comprise combinations of a green aluminate (GAL) and a red phosphor material(s) (e.g., to produce white light from the RGB Red Green Blue of blue led, green light, and red light). Green aluminate and a red nitride phosphor can be used alone or combined to generate white light when exposed to a blue LED excitation light source. The red nitride phosphor material can contain ions to promote quantum efficiency. The phosphor material can comprise a combination of a semiconductor nanocrystals of cadmium sulfide mixed with manganese; and/or a La₃Si₆N₁₁:Ce³⁺. A YAG:Ce phosphor material or a BOSE (boron ortho-silicate) phosphor, for example, can be utilized to convert the blue light to yellow.

The phosphor can comprise a down converting agent (such as (py)₂₄Nd₂₈F₆₈(SePh)₁₆, where py is pyridine, Nd is neodymium, Ph is phenyl), an up converting agent (such as 0.2 wt. % Ti²⁺:NaCl and 0.1 wt. % Ti²⁺:MgCl₂), or a combination comprising one or both of the foregoing. The phosphor can comprise an organic dye (such as Rhodamine 6G, Lumogen™ 083), a quantum dot, a rare earth complex, or a combination comprising one or more of the foregoing. The organic dye molecules can be attached to a polymer backbone or can be dispersed in the radiation emitting layer. The phosphor can comprise a pyrazine type compound having a substituted amino and/or cyano group, pteridine compounds such as benzopteridine derivatives, perylene type compounds, anthraquinone type compounds, thioindigo type compounds, naphthalene type compounds, xanthene type compounds, or a combination comprising one or more of the foregoing. The phosphor can comprise pyrrolopyrrole cyanine (PPCy), a bis(PPCy) dye, an acceptor-substituted squaraine, or a combination comprising one or more of the foregoing. The pyrrolopyrrole cyanine can comprise BF₂—PPCy, BPh₂-PPCy, bis(BF₂—PPCy), bis(BPh₂-PPCy), or a combination comprising one or more of the foregoing. The phosphor can comprise a lanthanide-based compound such as a lanthanide chelate. The phosphor can comprise a chalcogenide-bound lanthanide. The phosphor can comprise a transition metal ion such as one or both of Ti²⁺-doped NaCl and Ti²⁺-doped MgCl₂.

The phosphor can comprise a combination comprising at least one of the foregoing phosphors.

The phosphor can be free of an aluminum spinel, wherein a spinel has the structure A²⁺B₂³⁺O₄²⁻ (Al₂O₄²⁻ and A is a divalent alkaline earth element such as Ca²⁺, Sr²⁺, and Ba²⁺).

The phosphor-polycarbonate composition can comprise 0.5 wt. % to 20 wt. % or about 0.5 to about 20 wt. %, or 1 wt. % to 10 wt. % or about 1 wt. % to about 10 wt. %, or 2 wt. % to 8 wt. % or about 3 wt. % to about 8 wt. % of the phosphor based on the total weight of the composition. The phosphor-polycarbonate composition can comprise 0.1 parts by weight (pbw) to 40 pbw or about 0.1 to about 40, or 4 pbw to 20 pbw, about 4 pbw to about 20 pbw of the phosphor based on 100 pbw of polymer.

The phosphor can have a median particle size of about 10 nanometers (nm) to about 100 micrometers (μm), as determined by laser diffraction. The median particle size is sometimes indicated as D₅₀-value. The median particle size can be 1 μm to 30 μm or about 1 to about 30 micrometers, or 5 μm to 25 μm or about 5 to about 25 μm. Examples of median particle sizes include 1 μm to 5 μm or about 1 μm to about 5 μm, or 5 μm to 10 μm or about 5 to about 10 μm, or 11 μm to 15 μm or about 11 to about 15 μm, or 16 μm to 20 μm or about 16 to about 20 μm, or 21 μm to 25 μm or about 21 to about 25 μm, or 26 μm to 30 μm or about 26 to about 30 μm, or 31 μm to 100 μm or about 31 to about 100 μm.

The phosphor can be coated (e.g., result of applying a material to the surface of the phosphor, wherein the coating is on the surface and/or chemically interacts with the surface). Radiometric values (such as radiant power, radiant intensity, irradiance, and radiance) and corresponding photometric values (such as total luminance flux, luminous intensity, illuminance, luminance), luminance efficacy (in lumens per watt (lm/W)), color rendering index (CRI), color quality scale (CQS), correlated color temperature, and CIE 1931 chromaticity coordinates designated x,y and CIE 1976 (u′,v′) chromaticity coordinates designated u′,v′, can increase compared to the uncoated phosphor(s) when added to a polymer material such as polycarbonate.

The phosphor can be coated with a silicone oil and/or a layer of amorphous silica. Some examples of silicone oils include, but are not limited to: hydrogen-alkyl siloxane oil; polydialkyl siloxane oil; polydimethyl siloxane codiphenyl siloxane, dihydroxy terminated (such as Gelest PDS (polydimethyl siloxane) 1615 commercially available from Gelest, Inc.); as well as combinations comprising at least one of the foregoing. Such silicone oils are considered coatings where the phosphor is first treated with the silicone oil(s) prior to addition to a matrix or binder (collectively referred to as matrix), such as polycarbonate. The coating itself, is neither the binder nor the matrix that contains the phosphor to hold in place for exposure to blue LED radiation. Additionally, the coating does not require a curing method.

The phosphor can be coated with silicone oil e.g., by a method such as spraying the silicon oil. For example, the phosphor can be coated by spraying of the silicone oil in a fluidized bed reactor. The total amount of silicone oil can be 0.05 wt. % to 10 wt. % or about 0.05 to about 10 wt. % with respect to the phosphor, or 0.1 wt. % to 10 wt. % or about 0.1 wt. % to about 10 wt. %, or 0.5 wt. % to 5 wt. % or about 0.5 wt. % to about 5 wt. %, based upon the total weight of the phosphor. When two silicone coatings are used, such as polymethylhydrosiloxane and polydimethylsiloxane, the total amount does not change, and the split ratio between the two oils can be 1:99 to 99:1. The first coating can represent at least about 50 wt. % of the total silicone oil content.

Some examples of oils include polymethylhydrosiloxane (for example, DF1040 commercially available from Momentive Performance Materials) and polydimethyl siloxane (e.g., DF581 commercially available from Momentive Performance Materials). Other examples include diphenyl siloxane, e.g., silanol terminated oils such as silanol terminated diphenylsiloxane (e.g., PDS-1615 commercially available from Gelest, Inc., Morrisville, Pa.). The phosphor-polycarbonate composition can comprise up to about 4 parts per hundred (pph) by weight, or about 0.1 to about 0.5 (e.g., about 0.2) pph by weight of a pigment (e.g., Gelest PDS-1615). Other possible silanol terminated siloxanes include PDS-0338 and PDS-9931 also commercially available from Gelest, Inc. The phosphor-polycarbonate composition can comprise less than or equal to about 20 pbw of coated phosphor to about 100 pbw of polymer.

Additional phosphors include semiconductor nanocrystals such as quantum dots. Such materials include Cd-based, Cd-based core/shell passivated with ZnS shell, alloyed quantum dots such as cadmium-selenium-tellurium CdSeTe, indium phosphide InP, InP/ZnS core/shell and ZnSe/InP/ZnS core/shell/shell, copper indium sulfide CuInS₂, ZnS—CuInS₂ alloy with ZnS shell, and CuInS₂/ZnS core/shell materials. Yet other phosphors are manganese based phosphors such as K₂SiF₆:Mn⁴⁺, where K is potassium and Mn is manganese; K₂(TaF₇):Mn⁴⁺; KMgBO₃:Mn²⁺. Phosphors also include narrow band red phosphor: Sr[LiAl₃N₄]:Eu²⁺, where Li is lithium. A narrow-band phosphor, full width half maximum FWHM 25 nm-35 nm, or in some aspects less than 30 nm, absorbs 450 nm light, with a relative quantum yield greater than or equal to about 90% or in particular aspects greater than or equal to about 95%, and has a quantum yield loss to thermal quenching of less than about 10% at 150° C. In certain aspects narrow band emitting phosphors include a FWHM between about 50 nm and about 60 nm such as green emitting phosphors and europium doped thio-selenides. Phosphors include carbidonitride- and oxycarbidonitride-based phosphors. Other phosphors may be of the formula CaAlSiN₃:Eu.

### Diffusing Agents

Transparent is defined as a light transmittance of at least about 80% when tested in the form of a 3.2 millimeter (mm) thick test sample according to ASTM D1003-00 (2000) (hereby incorporated by reference in its entirety). Translucent is defined as a light transmittance greater than or equal to about 40% when tested in the form of a 2.5 mm thick test sample according to ASTM D1003-00 (2000). Opaque is defined as a light transmittance of about 10% or less when tested in the form of a 3.2 mm thick test sample according to ASTM D1003-00 (2000). The testing according to ASTM D1003-00 (2000) uses procedure A and CIE illuminant C and 2 degree observer on a CE7000A using an integrating sphere with 8°/diffuse geometry, specular component included, ultraviolet UV range included, large lens, and large area view, with percentage transmittance value reported as Y (luminous transmittance) taken from the CIE 1931 tristimulus values XYZ.

Translucent polycarbonates are formed using scattering agents such as light diffusers. The light diffusers often take the form of light diffusing particles or fibrils when blended and melt-mixed in a polymer such as polycarbonate, then used in the manufacture of articles that have good luminance. Such articles provide a high level of transmission of light (such as natural light through a window or skylight, or artificial light) with a minimum light loss by reflectance or scattering, where it is not desirable to either see the light source or other objects on the other side of the article.

An article, e.g., a sheet having a high degree of hiding power (i.e., luminance) allows a significant amount of light through, but is sufficiently diffusive so that a light source or image is not discernible through the panel. Light diffusers can be (meth)acrylic-based and include poly(alkyl acrylate)s and poly(alkyl methacrylate)s. Examples include poly(alkylmethacrylates), specifically poly(methyl methacrylate) (PMMA). Poly(tetrafluoroethylene) (PTFE) can also be used. Light diffusers also include silicones such as poly(alkylsilsesquioxanes), for example poly(alkylsilsesquioxane)s such as the poly(methylsilsesquioxane) available under the trade name TOSPEARL from Momentive Performance Materials Inc. The alkyl groups in the poly(alkyl acrylate)s, poly(alkylmethacrylate)s and poly(alkylsilsesquioxane)s can contain one to about twelve carbon atoms. Light diffusers can also be cross-linked. For example, PMMA can be crosslinked with another copolymer such as polystyrene or ethylene glycol dimethacrylate. In a specific aspect, the polycarbonate composition comprises a light diffusing crosslinked poly(methyl methacrylate), poly(tetrafluoroethylene), poly(methylsilsesquioxane), or a combination comprising at least one of the foregoing. Cyclic olefin polymers and cyclic olefin co-polymers can also be used to create diffusers.

Light diffusers also include certain inorganic materials, such as materials containing antimony, titanium, barium, and zinc, for example the oxides or sulfides of antimony, titanium, barium and zinc, or a combination containing at least one of the forgoing. As the diffusing effect is dependent on the interfacial area between polymer matrix and the light diffuser, in particular the light diffusing particles, the particle size of the diffusers can be less than or equal to 10 micrometers (μm). For example, the particle size of poly(alkylsilsesquioxane)s such as poly(methylsilsesquioxane) can be about 1.6 μm to about 2.0 μm, and the particle size of crosslinked PMMA can be about 3 μm to about 10 μm. Light diffusing particles can be present in the polycarbonate composition in an amount of 0 to about 1.5%, specifically about 0.001 to about 1.5%, more specifically about 0.2% to about 0.8% by weight based on the total weight of the composition. For example, poly(alkylsilsesquioxane)s can be present in an amount of 0 to about 1.5 wt. % based on the total weight of the composition, and crosslinked PMMA can be present in an amount of 0 to about 1.5 wt. % based on the total weight of the composition.

### PTFE

PTFE may be polymerized in a variety of ways; however the final product of each polymerization will possess different properties. One type of PTFE is a grade that can be molded into forms and films to increase the output of phosphor coated LEDs. This type of PTFE is known as a reflective material. The sintering process used for this type of PTFE involves applying heat (greater than about 350° C.) and pressure to fuse the particles together in a similar method to metal formation. This type of PTFE is held as a polymerized suspension (referred to as suspension PTFE), then separated and dried into a final powder form that may be milled or agglomerated to the desired size.

Another type of PTFE is emulsion PTFE. Emulsion PTFE is emulsion polymerized in a colloidal state, agglomerated in reactor, and then dried. They must also be sintered in order to maintain their strength in a finished part.

PTFE can be made in micropowder form and used as an additive for a variety of uses with other materials. PTFE micropowders are low molecular weight PTFE. Micropowders are not molded or formed due to poor mechanical strength, and generally cannot be sintered (even if heated and treated under pressure). PTFE micropowders are either formed from emulsion PTFE or made by the degradation of a high molecular weight PTFE via heat or electron beam irradiation followed by subsequent milling to the desired particle size.

The PTFE used in certain aspects of the present disclosure is PTFE micropowder formed from emulsion PTFE. Specifically, a low molecular weight PTFE additive having a molecular weight of about 300 K to about 400 K may be used with a specific surface area (SSA) of about 5 square meters per gram m²/g to about 10 m²/g. In some aspects, polycarbonate extrusions can be made using these PTFE micropowders at temperatures no greater than 300° C. (in contrast to extrusions using suspension PTFE which require temperatures of at least about 350° C. as noted above). The specifications of the PTFE micropowder used in aspects of the disclosure include, but are not limited to:

| | |
|---|---|
| Melting Point | 315-335° C. |
| Specific Surface Area | 5-10 m²/g |
| Particle Distribution: | |
| D₁₀ | 1.6 μm |
| D₅₀ | 10.5 μm (range of 5-16) |
| D₉₀ | 35 μm |

With respect to particle distribution, D represents the diameter of particles, D₅₀ is a cumulative 50% point of diameter (or 50% pass particle or the value of the particle diameter at 50% in the cumulative distribution); D₁₀ means a cumulative 10% point of diameter; and D₉₀ is a cumulative 90% point of diameter; D₅₀ is also called average particle size or median diameter.

In some aspects, the phosphor-polycarbonate composition may include PTFE from 0.1 wt. % to 4 wt. % or about 0.1 wt. % to about 4.0 wt. %, from 0.2 wt. % to 3.0 wt. % or about 0.2 wt. % to about 3.0 wt. %, and from 0.3 wt. % to 2.0 wt. % or about 0.3 wt. % to about 2.0 wt. %.

Extrusion with PTFE

This disclosure also relates to two methods in which product accumulation may be avoided during extrusion while also allowing for uniform appearance and structure of the final polycarbonate composition. In each of the methods, the addition of PTFE facilitates the formation of a uniform article in both structure and appearance. That is, the appearance of the article and its corresponding structure are homogeneous; the surfaces of the article are without variation in detail with respect to texture.

A first method involves mixing a thermoplastic polycarbonate composition with a phosphor component (PCP) and PTFE during the same extrusion step to form a PCP-PTFE composition. PCP-PTFE composition may be used in a final processing step to make the final lighting article such as a remote phosphor optical component. The processing step may be, for example, profile extrusion.

A second method to reduce product accumulation on the die-lip of an extruder during extrusion involves combining a phosphor component with a polycarbonate component to form a phosphor-polycarbonate master batch (PPCMB) composition. Separately, a polytetrafluoroethylene (PTFE)-PC master batch is formed. During the final processing step, the PTFE-PCMB is added to the PPCMB composition to form a PPCMB-PTFE composition.

In each of the above-described methods, reduction of product accumulation results in a corresponding increase in overall product yield of between about 50% and 100%.

In some aspects, the phosphor-polycarbonate composition exhibits an increase in CIEx as determined according to CIE 1931 or increase in (u′,v′) according to CIE 1976 of at least about 5% as compared to a substantially similar reference composition in the absence of PTFE. As used herein, substantially similar reference composition may be defined as a composition consisting essentially of the same amounts of the same components as the subject composition prepared under the same conditions within tolerance. However, the substantially similar reference may explicitly exclude certain components (e.g., PTFE) as a demonstration of the comparative performance between the compared compositions.

In other aspects, the phosphor-polycarbonate composition exhibits an increase in CIEx as determined according to CIE 1931 or CIE 1976 (u′,v′) of at least about 6% as compared to a substantially similar reference composition in the absence of PTFE, or at least about 7%, or at least about 8%, or at least about 9%, or at least about 10%, or at least about 11%, or at least about 12%, or at least about 13%, or at least about 14%, or at least about 15%.

Notably, the increase in CIEx described above relates to the diffusion of light, following excitation of a phosphor from blue LED photons. The blue excitation light source may in some aspects have peak intensity wavelengths of about 440 nm-470 nm or about 450 nm-470 nm, centered at about 460 nm.

The inclusion of PTFE in the composition also results in a corresponding decrease in correlated color temperature (CCT). Specifically, additional amounts of PTFE drive the CCT of the composition below 10,000K. Particular aspects of this disclosure include addition of PTFE to achieve a CCT of between about 3000 K and about 5000 K.

### Additional Components

In addition to the foregoing components, the disclosed phosphor-polycarbonate compositions can optionally include a balance amount of one or more additive materials ordinarily incorporated in phosphor-polycarbonate compositions of this type, with the proviso that the additives are selected so as to not significantly adversely affect the desired properties of the composition. Combinations of additives can be used. Such additives can be mixed at a suitable time during the mixing of the components for forming the composition. Exemplary and non-limiting examples of additive materials that can be present in the disclosed phosphor-polycarbonate compositions include one or more of a reinforcing filler, enhancer, acid scavenger, anti-drip agent, antioxidant, antistatic agent, chain extender, colorant (e.g., pigment and/or dye), de-molding agent, flow promoter, flow modifier, lubricant, mold release agent, plasticizer, quenching agent, flame retardant (including for example a thermal stabilizer, a hydrolytic stabilizer, a light stabilizer, or a combination thereof), impact modifier, UV absorbing additive, UV reflecting additive and UV stabilizer.

In some aspects, the phosphor-polycarbonate composition disclosed herein includes a stabilizer. A purely exemplary stabilizer is a phosphite stabilizer such as, but not limited to Irgafos™ 168, available from Ciba.

In certain aspects, the phosphor-polycarbonate composition may include an antioxidant such as a hindered phenol antioxidant. A purely exemplary hindered phenol antioxidant suitable for use in aspects of the disclosure includes, but is not limited to, Irganox™ 1076, available from Ciba.

In further aspects, the phosphor-polycarbonate composition disclosed includes a flame retardant. Potassium perfluorobutane sulfonate is an exemplary flame retardant additive.

In a particular aspect, the phosphor-polycarbonate composition may include from about 78.0 wt. % to about 83.0 wt. % high flow (HF) polycarbonate (PC) resin, from about 16.7 wt. % to about 20.0 wt. % general purpose PC, and from about 0.3 wt. % to about 2.0 wt. % PTFE. Further aspects may include additional components as described above. In some aspects the high flow (or ductile) polycarbonate is a polycarbonate that provides very high flow (e.g., about 40% greater than conventional polycarbonate), while maintaining the toughness and ductility for flowability that is typical in conventional polycarbonate. Exemplary high flow/ductile polycarbonates suitable for use in aspects of the present disclosure include the Lexan™ HFD line of polycarbonates, available from SABIC. For a given melt flow, Lexan™ HFD has about a 10-15° C. lower ductile/brittle transition temperature than conventional PC. In addition, Lexan™ HFD exhibits high ductility at temperatures down to about −40° C. (−40° F.), and it processes at temperatures about 11.1° C. (20° F.) lower than conventional PC having the same ductility.

### Examples

The following examples are intended to be illustrative and not limiting.

The following table is a representation of compounds comprising the disclosed thermoplastic composition including increasing amounts of the diffusing agent PTFE.

| Component | C1 | Ex1 | Ex2 | Ex3 | Ex4 |
|---|---|---|---|---|---|
| THPE branched PC resin | 63.61 | 63.27 | 63.11 | 62.94 | 62.61 |
| High flow (HF) PC resin | 31.95 | 31.79 | 31.7 | 31.62 | 31.45 |
| Phosphor component | 4.3 | 4.3 | 4.3 | 4.3 | 4.3 |
| (cerium-doped garnet) | | | | | |
| Potassium perfluorobutane | 0.06 | 0.06 | 0.06 | 0.06 | 0.06 |
| sulfonate (flame retardant | | | | | |
| additive) | | | | | |
| Irgafos ™ 168 | 0.06 | 0.06 | 0.06 | 0.06 | 0.06 |
| (phosphite stabilizer) | | | | | |
| Irganox ™ 1076 | 0.02 | 0.02 | 0.02 | 0.02 | 0.02 |
| (hindered phenol | | | | | |
| antioxidant) | | | | | |
| PTFE diffusing agent | 0 | 0.5 | 0.75 | 1.0 | 1.5 |
| Total: | 100 | 100 | 100 | 100 | 100 |

Values expressed as wt. % of total composition

The following ratios describe the disclosed phosphor-polycarbonate composition relative to the chromaticity coordinate CIEx. As seen in Table 2 below, with respect to a diffusing agent such as PTFE, chromaticity CIEx increases with increasing diffusing agent content.

YAG:Ce phosphor in PC pumped with blue LED

| Diffuser | CIEx | CIEx |
|---|---|---|
| (% wt) | (1.0 mm) | (1.5 mm) |
| 0.0 | 0.322 | 0.366 |
| 0.5 | 0.350 | 0.390 |
| 0.8 | 0.356 | 0.398 |
| 1.0 | 0.366 | 0.402 |
| 1.5 | 0.380 | 0.416 |

Similarly, chromaticity increases with increasing composition thickness. The Stokes efficiency of the PCP-PTFE and PPCMB-PTFE compositions decrease as chromaticity increases. Furthermore, the quantum efficiency and luminous efficacy of the PCP-PTFE and PPCMB-PTFE compositions decrease with increasing chromaticity.

As seen in Table 3 below, with respect to conversion efficacy, the phosphor-polycarbonate composition comprises a conversion efficacy value that reaches its greatest value between about 0.35 and about 0.45. Conversion Efficacy is equal to the ratio of white light lumens/blue optical (Watts).

YAG:Ce phosphor in PC pumped with blue LED

| | Approximate Conversion |
|---|---|
| Diffuser | Efficacy Maximum |
| (% wt) | for CIEx between 0.35 and 0.40 |
| 0.00 | 240 |
| 0.50 | 212 |
| 0.75 | 208 |
| 1.00 | 227 |
| 1.50 | 220 |

It is noted that the afore-described experimental results regarding LEXAN™ polycarbonate is particularly advantageous in that LEXAN™ polycarbonate has excellent mechanical properties, which combined with its inherent transparency, make it the material of choice for lighting applications such as lenses, lightguides and bulbs, as well as construction of roofing, greenhouses, verandas, and so forth. With the advent of LED technology, the functional lifetime of lighting products has increased impressively and will further expand in the years to come. Also, in construction applications, durability is important. Plastics will age, however, under the influence of heat, light and time, causing reduced light transmission and color changes. The inventors have herein addressed the above concerns and others, according to aspects of the disclosure, to explain the factors such as BPA purity level, sulfur level, hydroxy level, and type of process employed (interfacial) that can determine the optical material performance. The inventors have advantageously determined how optimization of such parameters during monomer and resin production can lead to further enhancement of color and color stability of the resulting plastic.

In certain aspects, the disclosed phosphor-polycarbonate composition may exhibit a particular Stokes efficiency and/or quantum efficiency. More specifically, the phosphor-polycarbonate composition comprises a Stokes efficiency and/or a quantum efficiency that decreases as chromaticity value increases. Stokes efficiency may refer to the amount of energy remaining after a fluorescence process takes place and thermalization losses occur within the fluorescent material. The Stokes efficiency may be quantified as the ratio of emitted energy to absorbed energy as described in Thesis, Design and Analysis of Fluorescent CeYAG Solar Concentrator, Abrar Sidahmed, McMaster University, October 2014. Quantum efficiency may refer to the ratio of emitted photons to incident photons multiplied by 100 to provide a percentage as described in Thesis, Design and Analysis of Fluorescent CeYAG Solar Concentrator, Abrar Sidahmed, McMaster University, October 2014.

### ASPECTS

The present disclosure comprises at least the following aspects.

Aspect 1. A method to improve remote phosphor optical properties in polycarbonate, the method comprising:

combining a phosphor component and a polycarbonate component to form a phosphor-polycarbonate composition; and
at a fixed phosphor concentration, combining the phosphor-polycarbonate composition with a diffusing agent comprising polytetrafluoroethylene (PTFE),
wherein the diffusing agent diffuses light, and
wherein the phosphor-polycarbonate composition exhibits an increase in CIEx when subjected to a blue LED excitation light source and as determined according to CIE 1931 or CIE 1976 (u′,v′) of at least about 5% as compared to a substantially similar reference composition in the absence of PTFE.

Aspect 2. A method according to Aspect 1, wherein the composition exhibits a CIEx based on CIE 1931 or CIE 1976 (u′,v′) of at least about 0.34 at 1 mm polycarbonate thickness and of at least about 0.38 at about 1.5 mm polycarbonate thickness when subjected to a blue LED excitation light source.

Aspect 3. A method according to Aspect 1, wherein the composition exhibits a CIEx based on CIE 1931 or CIE 1976 (u′,v′) of at least about 0.33 at 1 mm polycarbonate thickness and of at least about 0.37 at about 1.5 mm polycarbonate thickness when subjected to a blue LED excitation light source.

Aspect 4. A method according to Aspect 1, wherein the composition exhibits a CIEx based on CIE 1931 or CIE 1976 (u′,v′) of at least about 0.44 at 1 mm polycarbonate thickness and of at least about 0.52 at about 1.5 mm polycarbonate thickness when subjected to a blue LED excitation light source.

Aspect 5. The method according to Aspect 1, wherein the phosphor-polycarbonate composition comprises a correlated color temperature of less than about 10000K.

Aspect 6. The method according to Aspect 1, wherein the phosphor-polycarbonate composition comprises a correlated color temperature of from about 3000K to about 5000K.

Aspect 7. The method according to Aspect 1, wherein the phosphor-polycarbonate composition comprises:

from about 26.0 wt. % to about 83.0 wt. % high flow polycarbonate;
wherein a melt volume rate of the high flow polycarbonate is greater than about 15 by ISO 1133 at 300° C./1.2 kg, and
wherein a melt flow rate of the high flow polycarbonate is greater than about 15 by ASTM D 1238 at 300° C./1.2 kgf;

from about 16.7 wt. % to about 72.0 wt. % of a second polycarbonate (PC); and

from about 0.3 wt. % to about 2.0 wt. % PTFE.

Aspect 8. The method according to Aspect 1, wherein the phosphor-polycarbonate composition comprises:

from about 26.0 wt. % to about 83.0 wt. % high flow polycarbonate;
wherein a melt volume rate of the high flow polycarbonate is greater than about 15 by ISO 1133 at 300° C./1.2 kg, and
wherein a melt flow rate of the high flow polycarbonate is greater than about 15 by ASTM D 1238 at 300° C./1.2 kgf;

from about 16.7 wt. % to about 72.0 wt. % of a second polycarbonate (PC);

from about 0.3 wt. % to about 2.0 wt. % PTFE and

from about 0.5 wt. % to about 20 wt. % of a phosphor.

Aspect 9. The method according to Aspect 1, wherein the phosphor-polycarbonate composition comprises:

from about 60.0 wt. % to about 72.7 wt. % branched polycarbonate;

from about 25.6 wt. % to about 38.0 wt. % high flow polycarbonate;
wherein a melt volume rate of the high flow polycarbonate is greater than about 15 cm³/10 min as determined according to ISO 1133 at 300° C./1.2 kg, and
wherein a melt flow rate of the high flow polycarbonate is greater than about 15 g/10 min as determined according to ASTM D 1238 at 300° C./1.2 kgf;

from about 0.3 wt. % to about 2.0 wt. % PTFE,
wherein the PTFE diffuses light;

from about 0 wt. % to about 0.6 wt. % potassium perfluorobutane sulfonate;

from about 0 wt. % to about 0.6 wt. % phosphite stabilizer;

from about 0 wt. % to about 0.2 wt. % hindered phenol anti-oxidant; and

a phosphor,

wherein the phosphor-polycarbonate composition exhibits an increase in CIEx when subjected to a blue LED excitation light source and as determined according to CIE 1931 or CIE 1976 (u′,v′) of at least about 5% as compared to a substantially similar reference composition in the absence of PTFE.

Aspect 10. The method according to Aspect 1, wherein the phosphor-polycarbonate composition comprises:

from about 80.0 wt. % to about 99.5 wt. % transparent polycarbonate;
wherein a melt volume rate of the transparent polycarbonate is greater than about 15 cm³/10 min as determined according to ISO 1133 at 300° C./1.2 kg, and
wherein a melt flow rate of the transparent polycarbonate is greater than about 15 g/10 min as determined according to ASTM D 1238 at 300° C./1.2 kgf;

from about 0.3 wt. % to about 2.0 wt. % PTFE,
wherein the PTFE diffuses light;

from about 0 wt. % to about 0.6 wt. % potassium perfluorobutane sulfonate;

from about 0 wt. % to about 0.6 wt. % phosphite stabilizer;

from about 0 wt. % to about 0.2 wt. % hindered phenol anti-oxidant; and

a phosphor,

wherein the phosphor-polycarbonate composition exhibits an increase in CIEx when subjected to a blue LED excitation light source and as determined according to CIE 1931 or CIE 1976 (u′,v′) of at least about 5% as compared to a substantially similar reference composition in the absence of PTFE.

Aspect 11. The method of any one of Aspects 7-10, wherein the phosphor-polycarbonate composition comprises a chromaticity value that increases with increasing diffusing agent content.

Aspect 12. The method of any one of Aspects 7-10, wherein the phosphor-polycarbonate composition comprises a chromaticity value that increases with increasing composition thickness.

Aspect 13. The method of any one of Aspects 7-10, wherein the phosphor-polycarbonate composition comprises a Stokes efficiency that decreases as chromaticity value increases.

Aspect 14. The method of any one of Aspects 7-10, wherein the phosphor-polycarbonate composition comprises a quantum efficiency that decreases as chromaticity value increases.

Aspect 15. The method of any one of Aspects 7-10, wherein the phosphor-polycarbonate composition comprises a luminous efficacy value that increases as chromaticity value increases.

Aspect 16. The method of any one of Aspects 7-10, wherein the phosphor-polycarbonate composition comprises a conversion efficacy value that reaches its greatest value between 0.35 and 0.45 chromaticity CIEx.

Aspect 17. The method of any one of Aspects 7-10, wherein the diffusing agent is one or more of a composition comprising a methacrylic base, a polyalkyl acrylate, a polymethyl methacrylate (PMMA), silicone, a poly (alkyl silsequioxane), or a poly (methyl silsesquioxane).

Aspect 18. The method of any one of Aspects 7-10, wherein the diffusing agent is one or more of a composition comprising a cyclic olefin polymer, a cyclic olefin co-polymer, an inorganic compound, titanium, titanium oxide, barium sulfate, zinc, zinc oxide, or zinc sulfide.

Aspect 19. The method of any one of Aspects 7-18, wherein the polytetrafluoroethylene used is DuPont Zonyl™ MP1000 fluoroadditive.

Aspect 20. The method of any one of Aspects 8-19, wherein the phosphor is present in an amount from 0.5 wt. % to 20 wt. %.

Aspect 21. The method of any one of Aspects 8-19, wherein the phosphor is present in an amount from 1 wt. % to 10 wt. %.

Aspect 22. The method of any one of Aspects 8-19, wherein the phosphor is present in an amount from 2 wt. % to 8 wt. %.

Aspect 23. The method of any one of Aspects 8-19, wherein the phosphor is present in an amount of about 4 wt. % or about 3 wt. %.

Aspect 24. A method to increase yield of an extruded thermoplastic polycarbonate composition during an extrusion process, the method comprising:

combining a phosphor component and a polycarbonate component to form a phosphor-polycarbonate composition; and

at a fixed phosphor concentration, combining the phosphor-polycarbonate composition with a diffusing agent comprising polytetrafluoroethylene (PTFE),
wherein the diffusing agent diffuses light, and

wherein the phosphor-polycarbonate composition exhibits an increase in CIEx as determined according to CIE 1931 or CIE 1976 (u′,v′) of at least about 5% as compared to a substantially similar reference composition in the absence of PTFE.

Aspect 25. A method to increase yield of an extruded thermoplastic polycarbonate composition, the method comprising:

combining a phosphor component with a polycarbonate component to form a phosphor-polycarbonate master batch (PPCMB) composition;

during the combining, adding a diffusing agent comprising polytetrafluoroethylene (PTFE) composition to the PPCMB composition to form a PPCMB-PTFE composition;
wherein the diffusing agent diffuses light; and

wherein the phosphor-polycarbonate composition exhibits an increase in CIEx when subjected to a blue LED excitation light source and as determined according to CIE 1931 or CIE 1976 (u′,v′) of at least about 5% as compared to a substantially similar reference composition in the absence of PTFE.

Aspect 26. The method according to any one of Aspects 24-25, wherein the addition of PTFE results in a final thermoplastic polycarbonate composition uniform in structure and appearance.

Aspect 27. The method according to any one of Aspects—24-26, wherein the method results in an increase in yield during extrusion of from 50% to 100% relative to a substantially similar method that does not include PTFE in the phosphor-polycarbonate master batch composition.

Aspect 28. The method according to any one of Aspects 24-27, wherein the extrusion of the thermoplastic polycarbonate composition results in reduced accumulation of product on the die—lip of the extruder.

Aspect 29. The method according to any one of Aspects 24-28 wherein the polycarbonate is a continuous matrix material, and wherein phosphor and PTFE are additives.

Aspect 30. The method according to any one of Aspects 24-29, wherein PTFE is utilized to improve chromaticity and correlated color temperature for articles with a color rendering index of about 90.

Aspect 31. The method according to any one of claims 24-30, wherein PTFE is utilized to improve chromaticity and correlated color temperature for articles with a color rendering index of about 95.

Aspect 32. A composition comprising:

from about 80.0 wt. % to about 99.5 wt. % of a polycarbonate component;
wherein a melt volume rate of the polycarbonate component is greater than about 15 cm³/10 min as determined according to ISO 1133 at 300° C./1.2 kg, and
wherein a melt flow rate of the polycarbonate component is greater than about 15 g/10 min as determined according to ASTM D 1238 at 300° C./1.2 kgf;

from about 0.3 wt. % to about 2.0 wt. % PTFE,
wherein the PTFE diffuses light;

from about 0 wt. % to about 0.6 wt. % potassium perfluorobutane sulfonate;

from about 0 wt. % to about 0.6 wt. % phosphite stabilizer; and

from about 0 wt. % to about 0.2 wt. % hindered phenol anti-oxidant; and
wherein the composition exhibits an increase in CIEx when subjected to a blue LED excitation light source and as determined according to CIE 1931 or CIE 1976 (u′,v′) of at least about 5% as compared to a substantially similar reference composition in the absence of PTFE.

Aspect 33. A composition comprising:

from about 80.0 wt. % to about 99.5 wt. % of a polycarbonate component;
wherein a melt volume rate of the polycarbonate component is greater than about 15 cm3/10 min as determined according to ISO 1133 at 300° C./1.2 kg, and
wherein a melt flow rate of the polycarbonate component is greater than about 15 g/10 min as determined according to ASTM D 1238 at 300° C./1.2 kgf;

from about 0.3 wt. % to about 2.0 wt. % PTFE,
wherein the PTFE diffuses light;

from about 0 wt. % to about 0.6 wt. % potassium perfluorobutane sulfonate;

from about 0 wt. % to about 0.6 wt. % phosphite stabilizer;

from about 0 wt. % to about 0.2 wt. % hindered phenol anti-oxidant; and

a phosphor

wherein the composition exhibits an increase in CIEx when subjected to a blue LED excitation light source and as determined according to CIE 1931 or CIE 1976 (u′,v′) of at least about 5% as compared to a substantially similar reference composition in the absence of PTFE.

Aspect 34. The composition of Aspect 33, wherein the phosphor is present in an amount from 0.5 wt. % to 20 wt. %.

Aspect 35. The composition according to Aspect 33, wherein the polycarbonate component comprises:
from about 26.0 wt. % to about 83.0 wt. % high flow polycarbonate,
   wherein a melt volume rate of the high flow polycarbonate is greater than about 15 by ISO 1133 at 300° C./1.2 kg,
   wherein a melt flow rate of the high flow polycarbonate is greater than about 15 by ASTM D 1238 at 300° C./1.2 kgf, and
from about 16.7 wt. % to about 72.0 wt. % of a second polycarbonate (PC).

Aspect 36. The composition according to Aspect 33, wherein the polycarbonate component comprises:
from about 60.0 wt. % to about 72.7 wt. % branched polycarbonate;
from about 25.6 wt. % to about 38.0 wt. % high flow polycarbonate;
   wherein a melt volume rate of the high flow polycarbonate is greater than about 15 cm3/10 min as determined according to ISO 1133 at 300° C./1.2 kg, and
   wherein a melt flow rate of the high flow polycarbonate is greater than about 15 g/10 min as determined according to ASTM D 1238 at 300° C./1.2 kgf;

Aspect 37. The composition according to any one of Aspects 33-36, wherein the polycarbonate component is transparent.

### Definitions

Ranges articulated within this disclosure, e.g. numerics/values, shall include disclosure for possession purposes and claim purposes of the individual points within the range, sub-ranges, and combinations thereof. Various combinations of elements of this disclosure are encompassed by this disclosure, e.g. combinations of elements from dependent claims that depend upon the same independent claim. The word “about” should be given its ordinary and accustomed meaning and should be relative to the word or phrase(s) that it modifies.

The color blue, blue LED, blue LED photons, light and blue light as described herein are intended to cover peak intensity wavelengths between at least about 440 nm, or at least about 450 nm, or at least about 460 nm, or at least about 470 nm.

Ranges can be expressed herein as from one value (first value) to another value (second value). When such a range is expressed, the range includes in some aspects one or both of the first value and the second value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification. It is also to be understood that the terminology used herein is for the purpose of describing particular aspects only and is not intended to be limiting. As used in the specification and in the claims, the term “comprising” may include the aspects “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polycarbonate” includes mixtures of two or more such polycarbonates. Furthermore, for example, reference to a filler includes mixtures of two or more such fillers.

As used herein, the terms “optional” or “optionally” mean that the subsequently described event, condition, component, or circumstance may or may not occur, and that the description includes instances where said event or circumstance occurs and instances where it does.

As used herein, the term “combination” is inclusive of blends, mixtures, alloys, reaction products, and the like.

As used herein, the term “transparent” means that the level of transmittance for a disclosed composition is greater than about 50%. In some aspects, the transmittance can be at least about 60%, at least about 70%, at least about 80%, at least about 85%, at least about 90%, or at least about 95%, or any range of transmittance values derived from the above exemplified values. In the definition of “transparent”, the term “transmittance” refers to the amount of light that passes through a sample measured in accordance with ASTM D1003 at a thickness of 3.2 millimeters.

Disclosed are component materials to be used to prepare disclosed compositions as well as the compositions themselves to be used within methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

The abbreviation “LED” means “light emitting diode”.

An “analogous composition” is defined as being the same as the referred to composition except as noted in the description.

“PC” is the abbreviation for polycarbonate.

“PTFE” is an abbreviation for polytetrafluoroethylene. PTFE can be used as the principal additive acting as a light diffuser in the phosphor-polycarbonate composition.

“PMMA” is an abbreviation representing polymethyl methacrylate. PMMA is an example of a meth-acrylic based light diffuser.

“TSAN” is an abbreviation representing styrene/acrylonitrile encapsulated polytetrafluoroethylene.

“THPE” stands for tetrahydroxypropyl ethylenediamine. THPE can be used in the production of branched poly carbonates.

“CRI” stands for color rendering index, and is used to describe the fidelity of the color of a light source relative to the color observed in daylight or with an incandescent light source.

“CQS” stands for color quality scale.

“Wt %” (or “wt. %”) represents weight percent. Unless otherwise specified, wt. % is based on the total weight of the composition.

“V2” represents the result of the UL94 V-2 test at a certain thickness.

“Mol” is the abbreviation for mole(s).

“cm²” is the abbreviation for centimeters squared.

“mm” is the abbreviation for millimeter(s). When used in terms of thickness, the measurement is at the thinnest portion of the article.

“μm” is the abbreviation for micrometer. When used in terms of thickness, the measurement is at the thinnest portion of the article.

“nm” is the abbreviation for nanometer(s). When used in terms of thickness, the measurement is at the thinnest portion of the article.

“° C.” is degrees Celsius.

“kg” is the abbreviation for kilogram(s).

“g” is the abbreviation for gram(s).

“kgf/cm²” refers to a kilogram-force per square centimeter.

“pbw” is parts per weight.

“pph” is the abbreviation for parts per hundred.

“hr” is hour(s).

“min” is minute(s).

“s” is second(s).

References in the specification and concluding claims to parts by weight, of a particular element or component in a composition or article denotes the weight relationship between the element or component and any other elements or components in the composition or article for which a part by weight is expressed. Thus, in a composition containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

Compounds disclosed herein are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group. Unless defined otherwise, technical and scientific terms used herein have the same meaning as is commonly understood by one of skill in the art to which this disclosure belongs.

As used herein, the terms “number average molecular weight” or “Mn” can be used interchangeably, and refer to the statistical average molecular weight of all the polymer chains in the sample and is defined by the formula:

$$Mn = \frac{\sum {N}_{i} {M}_{i}}{\sum {N}_{i}} ,$$

where Mᵢ is the molecular weight of a chain and Nᵢ is the number of chains of that molecular weight. Mn can be determined for polymers, such as polycarbonate polymers or polycarbonate-PMMA copolymers, by methods well known to a person having ordinary skill in the art.

As used herein, the terms “weight average molecular weight” or “Mw” can be used interchangeably, and are defined by the formula:

$$Mw = \frac{\sum {N}_{i} {M}_{i}^{2}}{\sum {N}_{i} {M}_{i}} Mw = \frac{\sum {N}_{i} {M}_{i}^{2}}{\sum {N}_{i} {M}_{i}} ,$$

where Mi is the molecular weight of a chain and Ni is the number of chains of that molecular weight. Compared to Mn, Mw takes into account the molecular weight of a given chain in determining contributions to the molecular weight average. Thus, the greater the molecular weight of a given chain, the more the chain contributes to the Mw. It is to be understood that as used herein, Mw is measured gel permeation chromatography. In some cases, Mw is measured by gel permeation chromatography and calibrated with polycarbonate standards.

1. A composition comprising:
from about 80.0 wt. % to about 99.5 wt. % of a polycarbonate component;
wherein a melt volume rate of the polycarbonate component is greater than about 15 cm³/10 min as determined according to ISO 1133 at 300° C./1.2 kg, and
wherein a melt flow rate of the polycarbonate component is greater than about 15 g/10 min as determined according to ASTM D 1238 at 300° C./1.2 kgf;
from about 0.3 wt. % to about 2.0 wt. % PTFE,
wherein the PTFE diffuses light;
from about 0 wt. % to about 0.6 wt. % potassium perfluorobutane sulfonate;
from about 0 wt. % to about 0.6 wt. % phosphite stabilizer;
from about 0 wt. % to about 0.2 wt. % hindered phenol anti-oxidant; and
a phosphor,
wherein the composition exhibits an increase in CIEx when subjected to a blue LED excitation light source and as determined according to CIE 1931 or CIE 1976 (u′,v′) of at least about 5% as compared to a substantially similar reference composition in the absence of PTFE.

2. The composition according to claim 1, wherein the polycarbonate component comprises:
from about 26.0 wt. % to about 83.0 wt. % high flow polycarbonate,
wherein a melt volume rate of the high flow polycarbonate is greater than about 15 by ISO 1133 at 300° C./1.2 kg,
wherein a melt flow rate of the high flow polycarbonate is greater than about 15 by ASTM D 1238 at 300° C./1.2 kgf, and
from about 16.7 wt. % to about 72.0 wt. % of a second polycarbonate (PC).

3. The composition according to claim 1, wherein the polycarbonate component comprises:
from about 60.0 wt. % to about 72.7 wt. % branched polycarbonate;
from about 25.6 wt. % to about 38.0 wt. % high flow polycarbonate;
wherein a melt volume rate of the high flow polycarbonate is greater than about 15 cm³/10 min as determined according to ISO 1133 at 300° C./1.2 kg, and
wherein a melt flow rate of the high flow polycarbonate is greater than about 15 g/10 min as determined according to ASTM D 1238 at 300° C./1.2 kgf.

4. The composition according to claim 1, wherein the polycarbonate component is transparent.

5. A method to improve remote phosphor optical properties in polycarbonate, the method comprising:
combining a phosphor component and a polycarbonate component to form a phosphor-polycarbonate composition; and
at a fixed phosphor concentration, combining the phosphor-polycarbonate composition with a diffusing agent comprising polytetrafluoroethylene (PTFE) to form a phosphor-polycarbonate-PTFE composition,
wherein the diffusing agent diffuses light, and
wherein the phosphor-polycarbonate-PTFE composition exhibits an increase in CIEx as determined according to CIE 1931 or an increased CIE 1976 (u′,v′) of at least about 5% as compared to a substantially similar reference composition in the absence of PTFE.

6. The method according to claim 5, wherein the phosphor-polycarbonate-PTFE composition comprises a correlated color temperature of less than about 10000K.

7. The method according to claim 5, wherein the phosphor-polycarbonate-PTFE composition comprises a correlated color temperature of from about 3000K to about 5000K.

8. The method according to claim 5, wherein the phosphor-polycarbonate composition comprises:
from about 60.0 wt. % to about 72.7 wt. % branched polycarbonate;
from about 25.6 wt. % to about 38.0 wt. % high flow polycarbonate;
wherein a melt volume rate of the high flow polycarbonate is greater than about 15 cm³/10 min as determined according to ISO 1133 at 300° C./1.2 kg, and
wherein a melt flow rate of the high flow polycarbonate is greater than about 15 g/10 min as determined according to ASTM D 1238 at 300° C./1.2 kgf;
from about 0.3 wt. % to about 2.0 wt. % PTFE,
wherein the PTFE diffuses light;
from about 0 wt. % to about 0.6 wt. % potassium perfluorobutane sulfonate;
from about 0 wt. % to about 0.6 wt. % phosphite stabilizer;
from about 0 wt. % to about 0.2 wt. % hindered phenol anti-oxidant; and
a phosphor,
wherein the phosphor-polycarbonate composition exhibits an increase in CIEx when subjected to a blue LED excitation light source and as determined according to CIE 1931 or CIE 1976 (u′,v′) of at least about 5% as compared to a substantially similar reference composition in the absence of PTFE.

9. The method according to claim 5, wherein the phosphor-polycarbonate composition comprises:
from about 80.0 wt. % to about 99.5 wt. % transparent polycarbonate;
wherein a melt volume rate of the transparent polycarbonate is greater than about 15 cm³/10 min as determined according to ISO 1133 at 300° C./1.2 kg, and
wherein a melt flow rate of the transparent polycarbonate is greater than about 15 g/10 min as determined according to ASTM D 1238 at 300° C./1.2 kgf;
from about 0.3 wt. % to about 2.0 wt. % PTFE,
wherein the PTFE diffuses light;
from 0 wt. % to about 0.6 wt. % potassium perfluorobutane sulfonate;
from 0 wt. % to about 0.6 wt. % phosphite stabilizer;
from 0 wt. % to about 0.2 wt. % hindered phenol anti-oxidant; and
a phosphor,
wherein the phosphor-polycarbonate composition exhibits an increase in CIEx as determined according to CIE 1931 or CIE 1976 (u′,v′) of at least about 5% as compared to a substantially similar reference composition in the absence of PTFE.

10. The method according to claim 5, wherein the phosphor-polycarbonate composition comprises:
from about 26.0 wt. % to about 83.0 wt. % high flow polycarbonate;
wherein a melt volume rate of the high flow polycarbonate is greater than about 15 by ISO 1133 at 300° C./1.2 kg, and
wherein a melt flow rate of the high flow polycarbonate is greater than about 15 by ASTM D 1238 at 300° C./1.2 kgf;
from about 16.7 wt. % to about 72.0 wt. % of a second polycarbonate (PC); and
from about 0.3 wt. % to about 2.0 wt. % PTFE,
wherein the PTFE diffuses light.

11. The method of claim 5, wherein the phosphor-polycarbonate composition comprises a chromaticity value that increases with one or more of: increasing diffusing agent content and increasing composition thickness.

12. The method of claim 5, wherein the phosphor-polycarbonate composition comprises a Stokes efficiency and/or a quantum efficiency that decreases as chromaticity value increases.

13. The method of claim 5, wherein the phosphor-polycarbonate composition comprises a luminous efficacy value that increases as chromaticity value increases.

14. The method of claim 5, wherein the phosphor-polycarbonate composition comprises a conversion efficacy value that reaches its greatest value between about 0.35 and about 0.45 CIE 1931 CIEx chromaticity coordinate.

15. The method of claim 5, wherein the diffusing agent is one or more of a composition comprising a methacrylic base, a polyalkyl acrylate, a polymethyl methacrylate (PMMA), silicone, a poly (alkyl silsequioxane), or a poly (methyl silsesquioxane).

16. The method of claim 5, wherein the diffusing agent is one or more of a composition comprising a cyclic olefin polymer, a cyclic olefin co-polymer, an inorganic compound, titanium, titanium oxide, barium sulfate, zinc, zinc oxide, zinc sulfide.

17. A method to increase yield of an extruded thermoplastic polycarbonate composition, the method comprising:
combining a phosphor component with a polycarbonate component to form a phosphor-polycarbonate master batch composition; and
during the combining, adding a diffusing agent comprising polytetrafluoroethylene (PTFE) composition to the phosphor-polycarbonate master batch composition to form a phosphor-polycarbonate master batch—PTFE composition,
wherein the diffusing agent diffuses light,
wherein the phosphor-polycarbonate composition exhibits an increase in CIEx when subjected to a blue LED excitation light source and as determined according to CIE 1931 or an increased CIE 1976 (u′,v′) as compared to a substantially similar reference composition in the absence of PTFE.

18. The method according to claim 17, wherein the method results in an increase in yield during profile extrusion of from about 50% to about 100% relative to a substantially similar method that does not include PTFE in the phosphor-polycarbonate master batch composition.

19. The method according to claim 17, wherein PTFE is utilized to modify chromaticity and correlated color temperature for articles with a color rendering index of about 90.

20. The method according to claim 17, wherein PTFE is utilized to modify chromaticity and correlated color temperature for articles with a color rendering index of about 95.
